(19) United States
(12) Patent Application Publication
(10) Pub. No.: US 2008/0088130 A1
(43) Pub. Date: Apr. 17, 2008

(54) WIND POWER GENERATION DEVICE

(76) Inventor: Kuang-Chieh WU, Hsin Chu Hsien (TW)

Correspondence Address: LEONG C LEI, PMB # 1008, 1867 YGNACIO VALLEY ROAD, WALNUT CREEK, CA, 94598, US

(21) Appl. No.: 11/949,787

(22) Filed: Dec. 4, 2007

Related U.S. Application Data
(63) Continuation-in-part of application No. 11/356,067, filed on Feb. 17, 2006, now abandoned.

(51) Int. Cl. F03D 9/00

(52) U.S. Cl. 290/44; 290/55

(57) ABSTRACT

A wind power generation device includes a chassis carrying a wind power generation mechanism, primary and secondary power accumulators, and a driving mechanism. Power generated by the wind power generation mechanism is distributed to both accumulators. The primary accumulator functions to provide power output. The secondary accumulator is connected to the driving mechanism to supply power for driving a motor of the driving mechanism. The driving mechanism includes a gear train coupled between a spindle of the motor and a shaft of the wind power generation mechanism with a one-way bearing coupling the gear train to the motor spindle so that when the wind power generation mechanism is present in a wind still condition, the secondary power accumulator supplies electrical power to actuate the driving mechanism for maintaining operation of the wind power generation mechanism to generate electrical power that is supplied back to the primary and secondary power accumulators.

### CROSS-REFERENCE

This is a continuation-in-part of patent application Ser. No. 11/356,067, now pending.

### BACKGROUND OF THE INVENTION

(a) Technical Field of the Invention

The present invention relates to a wind power generation device, and in particular to a wind power generation device that can maintain operation in a wind still condition to provide an extended period of time for charging.

(b) Description of the Prior Art

Recently, due to the excessive development and consumption of fossil energy, including oil and coal, energy shortage is getting more and more severe. Wind power generation is one of the low-cost renewable energies currently available. Under the pre-requisite to maintain the operation and development of industry and business and to ensure living convenience of modern people, it become a vital issue for all human being around the world to widely apply the wind power generation to various respects of daily living in order effectively reduce the needs of using oil and coal to generate electrical power.

To satisfy the needs of communication, work, and entertainment, small-sized electrically-powered devices, such as mobile phones, personal digital assistants, multimedia players, digital cameras, and miniature lighting devices are now personally-carried and frequently-used portable personal accessories. Most of these devices are powered by rechargeable or secondary batteries contained therein. However, the rechargeable batteries are of limited power storage and can provide power only for a limited period of time. Once the rechargeable batteries are out of power, charging through for example wall outlets of electrical main must be carried out. This imposes a great burden to the world's power consumption.

Further, due to the limited period of time for supplying power, the rechargeable batteries often run out of power while used a user is traveling outdoor, where there is no convenient site for charging the batteries. A spare battery may be of help to overcome the problem. However, it often happens that the spare battery is left behind or it needs more power than the spare battery can supply. This also causes inconveniences.

In wind power generation technology, winds or blows are used to drive a fan, of which the mechanical energy is further used to drive a dynamo to generate electrical power. The electrical power is then charged to the rechargeable batteries or other types of power accumulators for output. The conventional wind power generation system is effective in providing renewable energy and helps reduce consumption of natural resources, but it cannot operate in a wind still condition. This is a problem to an urgent requirement of electrical power.

Thus, the present invention is aimed to provide a wind power generation device that is portable and maintain operation even in a wind still condition.

### SUMMARY OF THE INVENTION

The primary purpose of the present invention is to provide a wind power generation device that can maintain operation even in a wind still condition. To achieve the above objective, the present invention provides a wind power generation device comprising a chassis, which carries a wind power generation mechanism, a primary power accumulator, a secondary power accumulator, and a driving mechanism. The wind power generation mechanism, which is similar, in construction and operation principle, to the conventional wind power generation, comprises a shaft having an end to which a fan is mounted and an opposite end to which a magnet is mounted, a winding wound up around outside of the magnet, and a casing enclosing around the winding. By means of the rotation of the shaft, a relative rotation is caused between the magnet and the winding, which, based on the electromagnetic induction caused by the relative rotation, induces electrical current that is distributed to the primary and secondary accumulators. The primary power accumulator is further connected to an external socket for output of the electrical power. The secondary power accumulator is electrically connected to the driving mechanism to provide the driving mechanism with the power required for operation thereof. The driving mechanism comprises a motor and a transmission. The motor is electrically connected to the secondary power accumulator, and the transmission comprises a gear train coupled between a spindle of the motor and the shaft of the wind power generation mechanism. A one-way bearing couples the gear train to the spindle of the motor. With such a wind power generation device, when the fan is present in a wind still condition, the secondary power accumulator is controlled by a power switch to provide the driving mechanism with the power that the driving mechanism needs for operation in order to further drive the shaft to rotate for generation of electrical power, which is charged back to the primary and secondary power accumulators for extending the period of time for the primary accumulator to maintain power supplying.

The wind power generation device in accordance with the present invention can be further provided with a crank arm operatively coupled to the shaft by means of a gear train arranged between the crank arm and the shaft with the gear mounted to the crank arm by a one-way bearing so that when the wind power generation device is present in a wind still condition and both the primary and secondary power accumulators are of insufficient amount of power, manual operation of the crank arm can be employed to generate electrical power and the wind power generation device to realize manpower based electrical power generation.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic cross-sectional view of a wind power generation device constructed in accordance with a first embodiment of the present invention; and

FIG. 2 is a schematic cross-sectional view of a wind power generation device constructed in accordance with a second embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

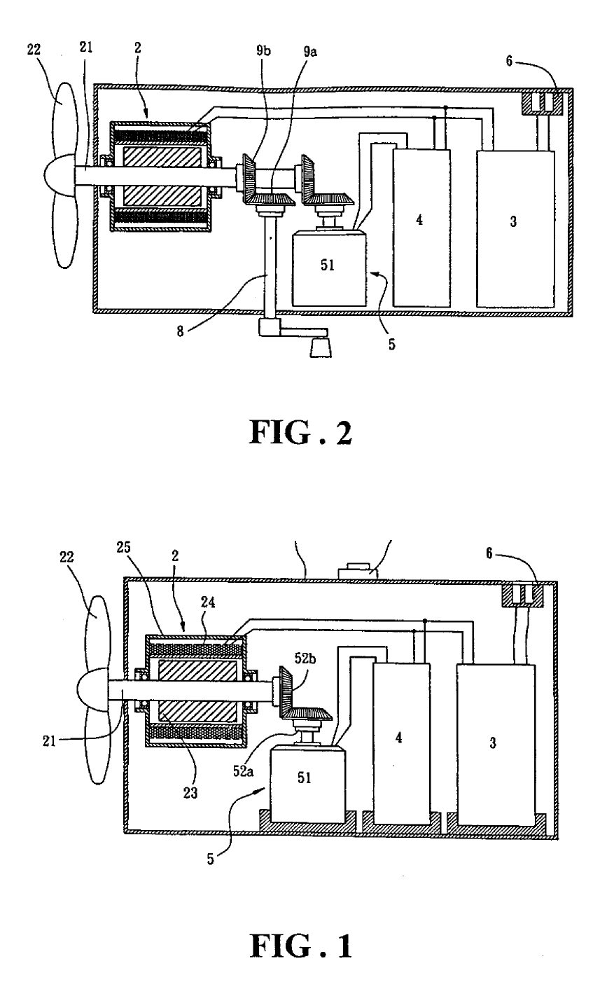

With reference to the drawings, and in particular to FIG. 1, a wind power generation device constructed in accordance with the present invention comprises a chassis (1) which carries a wind power generation mechanism (2), a primary power accumulator (3), a secondary power accumulator (4), and a driving mechanism (5).

The wind power generation mechanism (2) comprises a shaft (21) having a first end to which a fan (22) is mounted and an opposite second end to which a magnet (23) is mounted, a winding (24) wound up around outside of the magnet, and a casing (25) enclosing around the winding (24). The winding (24) is electrically connected to both the primary power accumulator (3) and the secondary power accumulator (4). When the fan (22) is driven to rotate the shaft (21), a relative rotation is caused between the magnet (23) and the winding (24), which, based on the electromagnetic induction, induces electrical current that flows through the winding (24) and is distributed to the primary and secondary accumulators (3, 4) through the electrical connection between the winding (24) and the accumulators (3, 4).

The primary power accumulator (3) functions to store electrical power generated by the wind power generation mechanism and is connected to an external connector, such as a socket (6), to supply an output of the electrical power.

The secondary power accumulator (4) also functions to store a portion of the electrical power generated by the wind generation mechanism and is controlled by a power switch (7) to selectively supply power to a driving mechanism (5) for operation thereof.

The driving mechanism (5) comprises a motor (51) having a spindle (not labeled) that is coupled to the shaft (21) of the wind power generation mechanism by a gear train which includes gears (52a, 52b) in the embodiment illustrated. The motor (51) is electrically connected to the secondary power accumulator (4). The gear (52a) is mounted to the spindle of the motor (51) by a one-way bearing (53) so that when the shaft (21) of the wind power generation mechanism is driven by the fan (22), the gear (52a) is allowed to freely rotate, which in turn allows the shaft (21) to rotate smoothly with reduced resistance.

To operate the wind power generation device of the present invention, when blows or winds act on the wind power generation device, similar to the conventional power generation, the wind drives the fan (22) to continuously rotate, and electrical power is continuously generated through the winding (24). The power is continuously charged to the primary and secondary power accumulators (3, 4) until they are fully charged. Most importantly, when the wind power generation device of the present invention happens to be present in wind still surroundings and the primary power accumulator (3) is insufficiently charged or is out of power, the secondary power accumulator (4) is controlled by the power switch (7) to supply electrical power to the driving mechanism (5) in order to actuate the driving mechanism (5) to drive the shaft (21) of the wind power generation mechanism (2) to rotate for generation of electrical power. The electrical power so generated is partially charged to the primary power accumulator (3) for output and the remaining power is supplied back to the secondary power accumulator (4) for further driving the driving mechanism (51).

FIG. 2 shows another embodiment of the wind power generation device in accordance with the present invention. The wind power generation device of the second embodiment further comprises a crank arm (8) operatively coupled to the shaft (21) by means of a gear train, which includes gears (9a, 9b) in the embodiment illustrated, arranged between the crank arm (8) and the shaft (21). The gear (9a) is mounted to the crank arm by a one-way bearing so that the crank arm does not interfere with the rotation of the shaft (21) by the fan (22). With such an arrangement, when the wind power generation device is present in a wind still condition and both the primary and secondary power accumulators (3, 4) are of insufficient amount of power, manual operation of the crank arm (8) can be employed to generate electrical power and the wind power generation device (2) is now turned into a manpower generation device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim

1. A wind power generation device comprising a chassis carrying a wind power generation mechanism, a primary power accumulator, a secondary power accumulator, and a driving mechanism, wherein the wind power generation mechanism is electrically connected to the primary and secondary power accumulators to distributed electrical power generated by the wind power generation mechanism to both primary and secondary power accumulators, the primary power accumulator being further connected to an external connector for output of the electrical power, the secondary power accumulator being further electrically connected through a power switch to a motor of the driving mechanism, the driving mechanism comprising the motor and a transmission, which comprises a gear train coupled between a shaft of the wind power generation mechanism and a spindle of the motor and a one-way bearing that couples the gear train to the spindle of the motor so that when a fan of the wind power generation mechanism is driven to rotate the shaft, the gear train coupled through the one-way bearing to the spindle of the motor is allowed to rotate freely, whereby when the wind power generation mechanism is present in a wind still condition, the secondary power accumulator supplies electrical power to actuate the driving mechanism for maintaining operation of the wind power generation mechanism to generate electrical power that is supplied back to the primary and secondary power accumulators.

2. The wind power generation device as claimed in claim 1, wherein the secondary power accumulator is controlled by a power switch to selectively actuate the motor of the driving mechanism.

3. The wind power generation device as claimed in claim 1 further comprising a crank arm, which is in operative coupling with the shaft by a transmission gear train, the crank arm being coupled to the transmission gear train by a one-way bearing, so that when the fan of the wind power generation mechanism drives the rotation of the shaft, the transmission gear train is allowed to rotate freely.
